(19) United States
(12) Patent Application Publication
(10) Pub. No.: US 2017/0323516 A1
(43) Pub. Date: Nov. 9, 2017

(54) ALPHANUMERIC LOTTERY GAME SYSTEM AND METHOD

(71) Applicant: Phrazzing Games, LLC, Powell, OH (US)

(72) Inventors: Gary F. Kadlec, Columbus, OH (US); Craig R. Sedoris, Dublin, OH (US)

(21) Appl. No.: 15/644,234

(22) Filed: Jul. 7, 2017

Related U.S. Application Data
(63) Continuation of application No. 14/458,753, filed on Aug. 13, 2014.
Application No. 14/458,753 is a continuation-in-part of application No. 14/273,535, filed on May 8, 2014.
(60) Provisional application No. 61/931,980, filed on Jan. 27, 2014.
(60) Provisional application No. 61/906,702, filed on Nov. 20, 2013.
(60) Provisional application No. 61/931,980, filed on Jan. 27, 2014.
(60) Provisional application No. 61/906,702, filed on Nov. 20, 2013.

(51) Int. Cl. G07F 17/32

(52) U.S. Cl. CPC G07F 17/329; G07F 17/3269; G07F 17/3225; G07F 17/326

(57) ABSTRACT

A lottery game and systems and methods for administering the lottery game wherein the lottery administrator defines game parameters that in turn define the contours of a game instance pool. Time based games are created by defining the duration for which the pool remains open to wagering or a date and time in the future when it closes. Pool based games are created by limiting pot size or number of participants and the pool is closed when the limit is reached. Outcome based games are created by defining or receiving multiple outcomes to be associated with bets placed. Wagers are made on plays of alphanumeric combinations that correspond to one or more entries into a pool array, from which one or more winners are chosen in a random drawing subsequent to the close of the pool.

### CROSS-REFERENCE TO RELATED APPLICATIONS

This nonprovisional application claims the benefit of U.S. Provisional Application No. 61/906,702 filed 20 Nov. 2013 and U.S. Provisional Application No. 61/931,980 filed 27 Jan. 2014, and is a continuation of U.S. Nonprovisional application Ser. No. 14/458,753 filed 13 Aug. 2014, which was a continuation in part of U.S. Nonprovisional application Ser. No. 14/273,535 8 May 2014, the contents of each being hereby incorporated by reference as if fully recited herein.

### TECHNICAL FIELD

Exemplary embodiments of the present invention relate generally to lottery games, games of chance or wagering type games, and more specifically to systems and methods for administering alphanumeric lottery type games.

### BACKGROUND OF THE INVENTION

Lottery draw-type wagering games have existed for many years and are well known in the art. Generally, players make a bet or play by selecting a wager amount (monetary or non-monetary) and a first wager set of numbers from a field of possible numbers. At a predefined time, the game is closed to further bets and a drawing is held. A second draw set of numbers is then selected from the field of possible numbers, either with or without replacement. The second set of numbers selected at the drawing can, for instance, be done manually by the random selection of numbered balls in a hopper or automatically in a computer routine.

A great number of games and variations thereon can be played based on this simple construct. For example, by varying whether the draw set of numbers is made with or without replacement, the number of possible outcomes can be enlarged or reduced, respectively. In some games, the order of the numbers chosen by the player in the wager set and drawn by the lottery administrator in the draw set, or subsets thereof, are used (e.g., a 1-2-3 wager set would be different from a 1-3-2 draw set, having only one choice in common).

In many games, the size of the wager set is the same as the size of the draw set. For example, in the Mega Millions multi-state lottery a player chooses 5 numbers from 59 possible numbers and 1 number from 46 possible numbers. The drawing set is then constructed by the same 5-from-59 and 1-from-46 selection method. In other games, for instance Keno-type games, the player chooses a wager set that is smaller in size than the eventual draw set, and payouts vary based upon the amount of matching numbers between the two sets.

A plethora of draw type lottery games has become available in an effort to keep potential players interested in such games of chance. Despite the great variety in the types of lottery drawing games that are available to players, however, virtually all such games are variations on, or simulations of, the antiquated concept of numbered ball lottery drawings—a basic gambling game design that has been around for centuries. Lottery game administrators are continually developing new game variations in order to keep interest levels elevated in the games, but many of today's technologically savvy crop of potential players desire exciting game variations that are not just a rehash of the tired “numbered ball” concept.

Additionally, many of the lottery type games available to players today are centrally designed and administered in a “one size fits all” manner that makes it difficult to cater to the geographic, location- or event-specific, or cultural differences among diverse players. The ability to easily tailor a large variety of lottery games for the tastes of a specific location, casino chain, geographic area, discrete event, theme or the like would greatly increase player excitement and therefore attract more players to take part in lotteries.

Some lottery systems provide for the public display of winners at the conclusion of the game in order to increase satisfaction and excitement for the players. There are currently no systems, however, that provide for the display of player information during a game in such a manner that allows players to be identified as a participant, either directly or indirectly, prior to the lottery drawing. Nor do known systems generally allow the player to control the manner in which they are identified upon winning a game. Therefore, there exists a need in the prior art for publicly displaying information provided by game participants and identifying wagers played by the participants.

Furthermore, the existence of a variety of draw type lottery games in the prior art does not translate to administrative ease regarding the offering of a large selection of games to players. Many game types must be offered in isolation from other games, and may each require multiple systems to make a multitude of games available. Attempts to overcome this type of shortcoming have been made, but leave the player with the impression that the game in which they are participating is one of many, potentially detracting from the excitement of the game. For instance, one reference describes a grid-based lottery system and method that permits a single lottery drawing to be used across a plurality of different game types by utilizing a grid that corresponds to the drawing, and wherein each grid location may contain randomly distributed game elements or may be empty. For any particular game, the number of grid elements or game elements that are usable may differ from the amount drawn, clearly indicating to the player that the drawing is applicable to other games in which he or she is not participating.

It is therefore an unmet need in the prior art for lottery game systems and methods that permit lottery administrators and locations greater flexibility in the types of games offered, and that are not restricted to numbered ball lottery games, but rather provide for games based on alphanumeric characters and symbols, each having its own corresponding drawing, thereby providing increased excitement, meaning and participation for the games, and further providing for easily administered location or event themed games. No known references, taken alone or in combination, are seen as teaching or suggesting the presently claimed apparatus for holding an electronic device at a work surface.

### BRIEF SUMMARY OF THE INVENTION

One object of the invention is to provide a means by which to ensure that each instance of the lottery game will have at least one winner, or multiple winners if desired. In some embodiments, the at least one winner may be the “house” or lottery administrator. Via a gaming device, a player chooses an instance of the lottery game. Embodiments of the lottery game includes, for each instance of the game, a corresponding pool comprised of the bets made by the players participating in that particular instance of the game and the wager amounts made by those players. Once a pool is open, players may choose to participate in that pool until it is closed at a time that varies depending upon a few simple parameters chosen by a lottery administrator for the game instance. When a player participates by choosing (either manually or automatically) a set of alphanumeric characters (i.e., a “bet” or “play”) and a wager amount, one or more entries are made into a pool array, wherein a given participant's play serves to “label” the entries belonging to that participant. When the pool is closed, the pool array consists of a final, total number of entries. In some embodiments, these entries may or may not include “house” entries, if desired. A drawing is held and one of the equally weighted entries is chosen at random as the winner, or as one of a group of finalists/winners defined by themed game parameters. A player's bet into a given pool is used to provide a combination of alphanumeric characters that identifies the player and lends much greater flexibility in choice by the player.

Another aspect of the invention is that games are configured with a bet increment, or predefined “cost” for one pool entry, as it is desirable for each entry into a pool array to be equally weighted in order to truly randomize and simplify the drawing process. A bet increment parameter is stored by the system, and each wager placed by a game participant is a multiple of the bet increment.

Another object of the invention is to provide lottery administrators with the ability to create a wide variety of games based on relatively few parameters in order to create exciting variations and allow for tailoring of games to fit desirable demographics or themes. For example, one aspect of the invention is to allow the creation of games in which the pool is open for a specific duration of time, optionally repeatable in a consecutive string of games with no limit on the pool size. Another aspect of the invention is a time based game in which the pool closes on a specific date or time in the future.

Further aspects of the invention allow for the creation of pool based games in which the pool is open until a predefined characteristic of the pool reaches a specified limit. For example, administrators may create games in which the pool stays open until a pot size (i.e., total winnings, or total paid in) or number of players is attained.

Another object of the invention is to provide a method of administrating a lottery game that includes a wagering portion and a resolution portion. The steps of the method include: establishing a lottery game by defining a set of game parameters, including a termination parameter and a set of valid wager parameters, on an administration server, opening an instance of the lottery game for play on the administration server, establishing a wager pool based on the set of valid wager parameters, conducting, with a user of a gaming device, a wagering portion of the lottery game on the administration server, the wagering portion including the steps of: establishing an interactive communication between the administration server and the gaming device, providing game rules and information to the gaming device, qualifying the user of the gaming device as an eligible player, requesting wager and payment information, receiving, provisionally, the wager and payment information from the gaming device, validating the received wager and payment information, rejecting the received wager and payment information if either or both of the received wager and payment information are not valid, rejecting the received and validated wager and payment information if accepting the received and validated wager and payment information would cause the termination parameter to be exceeded, and accepting the received and validated wager and payment information as an accepted entry by storing the received and validated wager and payment information in a wager pool. The method may further include the step of conducting a resolution portion of the lottery game, the resolution portion including the steps of: closing the wager pool by appending one or more house entries thereto wherein the number of the one or more house entries appended is based on the set of valid wager parameters and the set of termination parameters, establishing a prize payout, and drawing a winner from the wager pool.

Another object of the invention is to disburse the prize payout to the winner selected in the resolution portion.

One exemplary embodiment includes one of the game parameters being that the wager information received from the player is a sequence having a predetermined number of characters selected from the group consisting of: upper case alphabetic characters, lower case alphabetic characters, Arabic numerals and a predetermined set of special characters.

Some embodiments include one of the game parameters being that the wager information received from the player is a sequence having a predetermined number of characters selected from a set of possible characters. Yet others employ a set of possible characters that includes at least alphabetic characters, Arabic numerals and a predetermined set of special characters. In one embodiment, the set of special characters are selected from the group consisting of: !, $, @, and #.

In some embodiments the step of validating the received wager information includes the steps of: verifying that the received wager information is a sequence having a number of characters within a range of the number of characters that is predetermined in the valid wager parameters, and verifying that each character in the received wager information is within a range of characters that is predetermined in the valid wager parameters.

Another object is to include a step of verifying that the received wager information does not contain any sequences of characters contained in a predetermined library of excluded sequences.

The lottery game administered by the administration server carrying out the steps of the method may be a time-based game. In some time-based games, the termination parameter may be a predetermined date and time. In other time-based games, the termination parameter may be a predetermined amount of time after the instance of the game is opened for wagering.

It is another object to provide lottery games that are pool-based games. In some embodiments, the termination parameter is a predetermined pot size. In other embodiments, the termination parameter may be a predetermined number of accepted entries stored in the wager pool.

Another object is to provide lottery games that are outcome-based games. In some embodiments, the termination parameter may be a predetermined event, or the occurrence thereof. In other embodiments the termination parameter includes a predetermined date and time.

In some embodiments, the wager information received from the player may comprise an outcome parameter selected from a predetermined set of possible outcomes, and a player identifier, defined as a sequence having a predetermined number of characters selected from the group consisting of: upper case alphabetic characters, lower case alphabetic characters, Arabic numerals and a predetermined set of special characters.

Another object is to provide a step of determining a winner from the wager pool that includes the steps of: determining a winning outcome from the predetermined set of possible outcomes, assembling a winner pool from the wager pool entries where the wager information has a selected outcome parameter equal to the winning outcome, and if there is more than one entry in the winner pool, conducting a drawing to determine a winning entry from the winner pool.

Another object is to provide the step of drawing a winner from the wager pool by executing a software routine on the administration server that randomly selects a winning entry from the wager pool. In some embodiments, the step includes: randomly selecting a first character in a sequence randomly selected from the entries in the wager pool, discarding all entries in the wager pool that have a first character that is different from the first character selected in the previous step, repeating the previous two steps for a next character adjacent in position to the previously tested character, and displaying a winning sequence constructed from the randomly selected characters.

In some embodiments, the wagering portion may further include the steps of: randomly selecting a sequence from the entries in the wager pool, and displaying the sequence on a display.

It is another object to provide a method of playing a lottery game that comprises a wagering portion and a resolution portion, the method including the steps of: receiving, on a gaming device in communication with an administration server hosting the lottery game, game rules and information about an open instance of the lottery game for which games parameters, including a termination parameter and a set of valid wager parameters, have been established on the administration server, establishing an entry in a wager pool of the game by: providing, through the gaming device: qualification information requested by the administration server to qualify the user as an eligible player, and wager and payment information requested by the administration server after the user is qualified as an eligible player, and receiving, through the game device, an acceptance of the entry into the wager pool, and receiving, through the gaming device, information that the wager pool has been closed and information regarding the resolution portion, including a winner and a prize payout. In some embodiments, the termination parameter is at least one of: a predetermined date and time, a predetermined amount of time after the instance of the game is opened for wagering, a predetermined pot size, and a predetermined event.

These and other advantages are provided by the invention described and shown in more detail below.

### BRIEF DESCRIPTION OF THE SEVERAL VIEWS OF THE DRAWINGS

Novel features and advantages of the present invention, in addition to those mentioned above, will become apparent to those skilled in the art from a reading of the following detailed description in conjunction with the accompanying drawings wherein identical reference characters refer to identical parts and in which:

FIG. 1 is a schematic view of an exemplary embodiment of an alphanumeric lottery gaming system;

FIG. 2 is a flow diagram of an exemplary method related to the administration of the alphanumeric lottery game;

FIG. 3 is a flow diagram of an exemplary method of alphanumeric lottery game creation; and

FIG. 4 is a flow diagram of an exemplary method of alphanumeric lottery game wagering.

### DETAILED DESCRIPTION OF THE INVENTION

Exemplary embodiments of the present invention are directed to new lottery games, and to systems and methods of administering them. The invented game distinctly departs from the traditional lottery draw-type game in which a group or field of numbers are used as the drawing pool. Instead, the invented game utilizes a play of virtually any combination of letters, numbers, symbols and other such indicia (e.g., “@” and “#”) to represent a player's wager, thereby permitting a much greater level of customization and personalization in a player's selection, or bet. As described in further detail below, a player may input a combination of alphanumeric characters when making a wager, and in doing so may choose to play combinations that have a more modern meaning, such as Twitter handles (e.g., “@playername”) or trending hash tags (e.g., “#casinonight”), or combinations that have a greater appeal to superstitious players by adding an additional degree of “luck” to the bet by playing the names of grandchildren, street addresses portions, or favorite colors, numbers, alma maters or sports teams, for instance.

A player's bet may serve, for instance, to either directly or indirectly identify the player who made the wager. For example, a player may wish to play his or her name and favorite number as a combination. Other players may play nicknames, favorite team names, inside jokes or other similarly meaningful combination that indirectly associates the chosen combination with the player, but does not necessarily identify the person that made the wager to those in the general public. As will be described in further detail below, the lottery game may optionally include the use of a means for displaying participant combinations while the game is open, in order to further increase the excitement of the game.

The final combination chosen by a player can optionally be compared to a list or database of character strings that contain potentially profane, sexual, racist or other offensive terms before being allowed to proceed with the bet. If the combination chosen by the player corresponds to, or contains a substring that matches, an illicit term in the “banned” or disallowed terms list or database, then the player will be notified that the combination is not permissible as a play. To continue, the player will be asked to enter another combination. It is preferred that player combinations are compared against such a list because, as will be described in further detail below, the chosen player combinations may eventually be displayed publicly on conspicuous displays in certain circumstances, and in particular when a winning combination is announced.

A preferred embodiment of the invention permits players to chose any combination of letters (A-Z and a-z), numbers (0-9), and the symbols “@”, “#” and “&” where the final combination upon which the player wishes to place a bet has between 1 and 20 characters. It should be understood that less or more of the preferred set of possible alphanumeric characters may be available to players without departing from the scope of this disclosure. Furthermore, the total number of consecutive characters permitted (no spaces being preferred but not mandatory) may be altered depending upon a specific application and desire of those using the invention, and the range of 1-20 characters is merely provided by way of example. The game administrator may optionally choose a minimum or maximum number of characters that a player may choose in any given combination, or both (i.e., a fixed-length bet in the latter case). Similarly, symbols other than the “@”, “#” and “&” symbols may be used as potential characters if desired, and ultimately the set of possible alphanumeric characters from which players construct a bet name may be comprised of any desired group of indicia, including upper and lowercase letters, numbers, punctuation, non-English characters, emoticons, other symbols and the like, and it is not intended that the possible indicia be limited by this disclosure. The characters chosen by a player are also preferably able to be repeated in a single combination. For instance, a player might wish to play combinations such as “LADYLUCK777”, “#GoBucks13”, “@JohnSmith” or “Scarlet&Gray”. It should be understood that other restrictions or additional characters may be made available without departing from the scope of the invention.

The invented lottery game may be implemented to ensure that each instance of the game will have at least one winner, or multiple winners if desired. In some embodiments, the winner may be the “house”—e.g., the lottery administrator. Via a gaming device, a player chooses an instance of the lottery game. Every instance of the lottery game has a corresponding pool comprised of one or more players participating in that particular instance of the game representing the bets made by those players. Once a pool is open, players may choose to participate in that pool until it is closed at a time that varies depending upon the parameters defined for the game instance. When a player participates by choosing a set of alphanumeric characters (a “selection” or “play”) and a wager amount, one or more entries are made into a pool array, or wager pool, wherein a given participant's play serves to label the entries belonging to that participant. When the pool is closed, the pool array consists of a final, total number of entries. A drawing is held and one or more of the equally weighted entries is chosen at random as the winner, or as one of a group of finalists/winners. In other embodiments described in further detail below, the winner may be chosen alternatively based on event outcomes or as compared to a winning value. A player's bet into a given pool is used to provide a combination of alphanumeric characters that identifies the player and lends much greater flexibility in choice by the player.

Because each entry into a pool array is preferably equally weighted in order to truly randomize the drawing process or to provide for equal shares of proceeds, game instances have a predefined “cost” assigned to pool entries. A bet increment parameter is stored by the system, and the wager amount placed by a game participant may be either equal to or a multiple of the bet increment. For example, the bet increment might be $1, with no maximum wager amount specified for a particular game. A player wagering $25 on the play “RedWhite&Blue” would result in “RedWhite&Blue” being entered into the pool array 25 times. Another game might be configured with a bet increment of $25, and in that game the same wager ($25 on “RedWhite&Blue”) would result in only a single entry into the pool array. Bet increments could be $1, $5, $10, etc., and it will be understood that those creating specific instances of the lottery game are limited only by practical considerations in terms of the bet increments that may be specified.

Players may participate in embodiments of the invented lottery game generally by way of a gaming device. It is preferred that the invention be implemented in part on one or more computing devices having input/output means, memory, data storage or generally a combination thereof suitable for the purposes described herein in view of a particular application, and one or more processors. A “gaming device” for the purposes of this disclosure means any such computing device on which a player may participate by placing a bet in a lottery game of the type disclosed herein. Participation in the game includes the ability to choose a specific game instance in which to participate, to choose a bet name or play—i.e., a combination of characters chosen from the group of possible indicia—and to place a wager amount thereon (e.g., a monetary or non-monetary sum having a definable value). A player may participate by manipulating a gaming device in order to carry out those tasks, or by corresponding with one or more intermediaries that manipulate a gaming device on behalf of the player (e.g., a ticket window clerk or electronic broker).

Gaming devices may include, without limitation, mobile phones, personal computers, tablets, laptops, kiosks, mainframe access terminals, servers, game cabinets such as those commonly used in casinos and other locations, point of sale terminals and the like. The gaming device may embody the invented systems and methods disclosed herein by way of executable software code or routines programmed and stored within its data storage means or on computer-readable media, on a second networked device accessed by the gaming device, such as a lottery game administration server, by execution of instructions received remotely, or a combination thereof. Some functions of the gaming device, such as accepting payment, may be carried out by way of periphery device, such as a card reader, for instance.

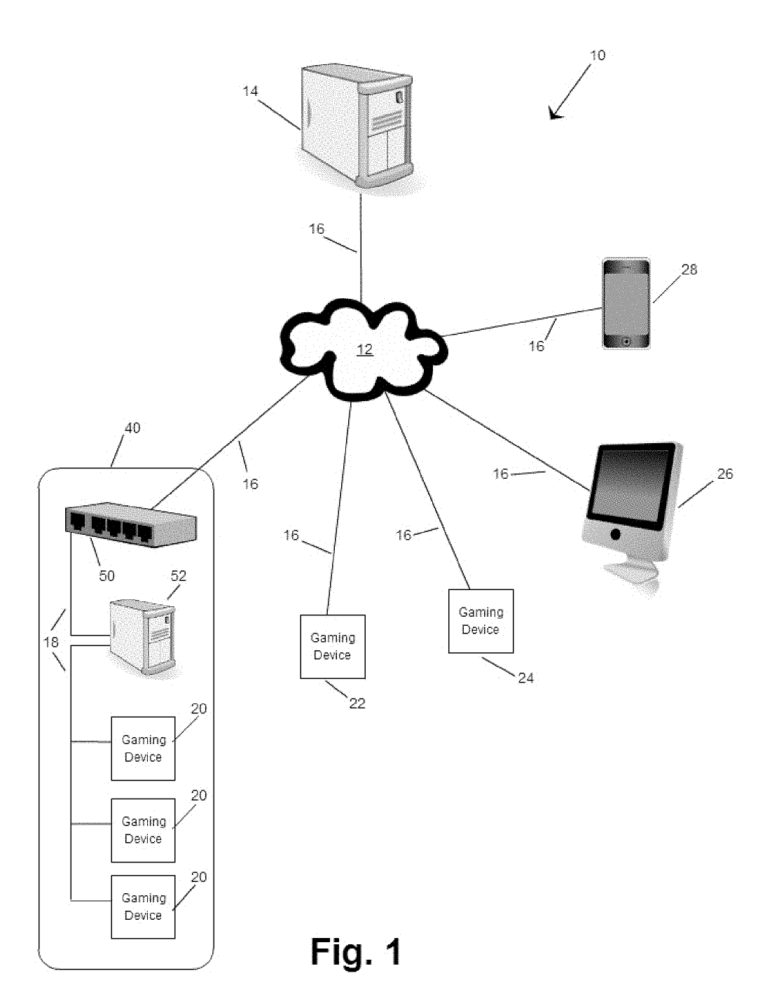

FIG. 1 is a schematic view of an exemplary embodiment of an alphanumeric lottery gaming system 10 in accordance with the invention. The components of the system 10 may operatively be connected via a network 12, which represents any suitable means of communication among the system components. Depending upon the particular embodiment, the network 12 may comprise one or more data communication/network means such as private networks, the internet, wide (WAN) and local (LAN) area networks, a virtual private network (VPN), cellular or other wireless networks, digital subscriber (DSL) or other telephone line, Bluetooth connection, etc. A plurality of gaming devices as previously described are depicted in communication with a lottery administration server 14. Communications links 16 are shown and generally represent data/communication connections of types corresponding to the particular network 12 composition chosen for a given implementation, and may represent the combination of several physical links or protocols. For example, the data links 16 may represent one or more wired or wireless connections such as a WiFi, Bluetooth, telephone, Ethernet, 3G, LTE, optical fiber, satellite, cable, T1, T3 or other such link appropriate to carry out communication via the network configurations chosen.

The lottery game administration server 14 is also operatively connected to the network 12 via a communication link 16. For the purposes of this disclosure, a “lottery administration server” is defined as a computing device or group of such devices programmed and configured to administer a lottery game as described herein. It can be embodied in a single computing device, such as a desktop or laptop computer, a single server or scalable rack server system, or the like. It may also be embodied as a group of networked servers, for instance, and may include one or more databases, database servers, payment processing gateways, and the like. Although the lottery administration server 14 depicted in connection with FIG. 1 is shown as a single computing device, it will be understood that the server 14 may comprise multiple devices operating together, and that to avoid confusion, this disclosure does not describe in detail the structures or equivalents known to those skilled in the art for performing some of the sub-functions described herein. In general, the meaning of the term lottery administration server is meant to encompass one or more computing devices generally including input/output means, memory, data storage or generally a combination thereof suitable for the purposes described herein in view of a particular application, one or more processors, and executable software code or routines programmed and stored within its data storage means or on computer-readable media, or on a second networked device accessible to the lottery administration server, or a combination thereof.

The lottery administration server 14 is utilized by a lottery administrator generally to make the lottery game available to others to play. Lottery administrators include, for instance, casinos, gaming enterprises, lottery commissions or the like. Those skilled in the art will appreciate that the lottery administration server 14 can include systems necessary to process and account for wagers, or can be communicatively linked to a third party vendor that contracts to provide those services. The lottery administration server 14 can include high security electronic data systems for the handling of sensitive information separately from non-sensitive information. For the purposes of brevity and clarity in the instant description of the invention, such subsystems known to and readily applied by those skilled in the art will not be described in detail in this disclosure.

The alphanumeric lottery gaming system 10 includes a plurality of gaming devices 20, 22, 24, 26 and 28. As mentioned previously, the gaming device may be configured as a self-service gaming device similar to keno machines currently found in casinos and other entertainment facilities. Several gaming devices 20 may be grouped together on a subnet, for example all of the gaming devices 20 at a particular casino 40 may be networked together by a communication link(s) 18, with access to the network 12 controlled by a router or other such known networking devices 50, one or more additional location or subnet-specific lottery administration server components 52, or a combination thereof. Other standalone gaming devices 22, 24 may be located individually at various locations, including convenience stores, bars and restaurants, and other desired locales. For example, gaming device 22 might be a self-service gaming cabinet located at a tavern. Gaming device 24 might be a point of sale lottery gaming device operated by a convenience store clerk to place wagers on behalf of customers and to provide the customer with a lottery ticket in paper, or electronic format, for instance.

In the aforementioned embodiments, the gaming device 20, 22 and 24 may have executable instructions stored in data storage means or removable computer-readable media for displaying a user interface to assist players in placing a wager. Alternatively, the gaming device 20, 22 and 24 may act as a terminal, wherein the lottery administration server 14 executes the code to perform the steps described herein. Those and other gaming devices, such as the personal computer 26 and mobile phone 28 embodiments, may similarly use one or a combination of these methods to implement the lottery game. For example, the mobile phone gaming device 28 might execute software code from an installed mobile application, interacting with the lottery administration server 14 to allow a player to place bets using the phone 28. The personal computer 26 may be used to visit a website in a similar manner, or vise versa.

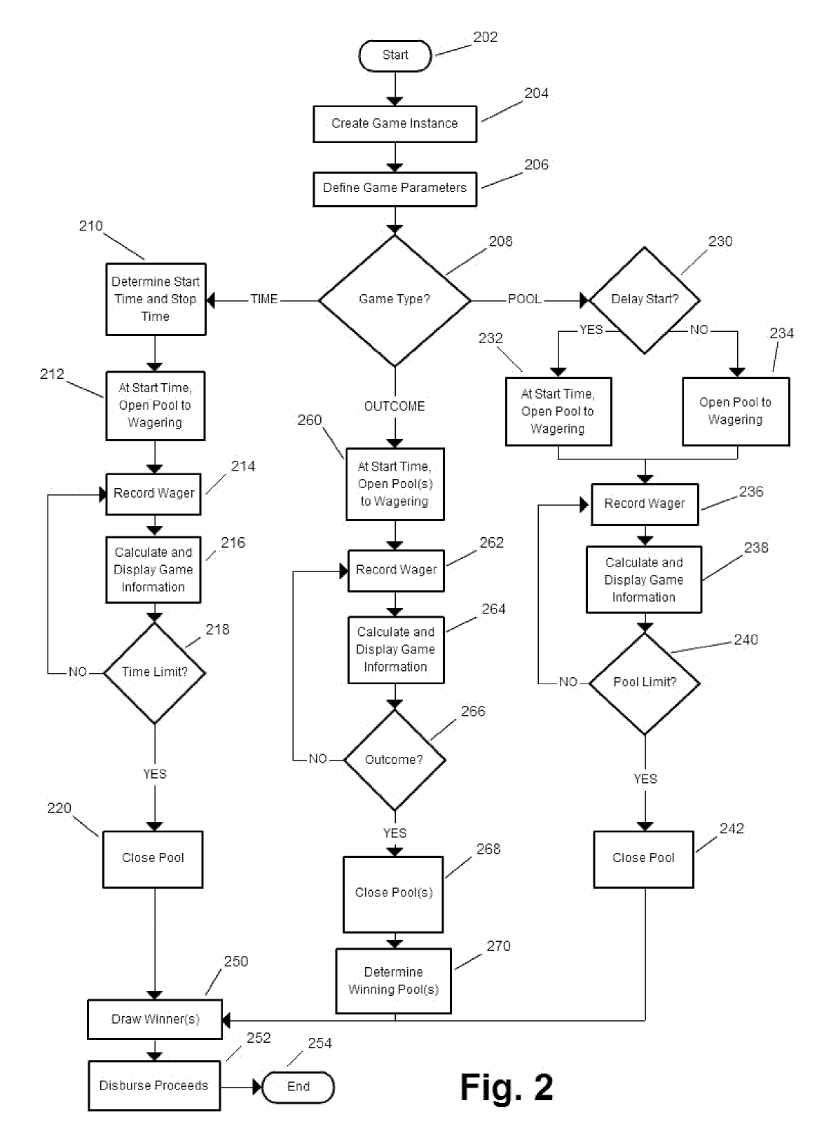

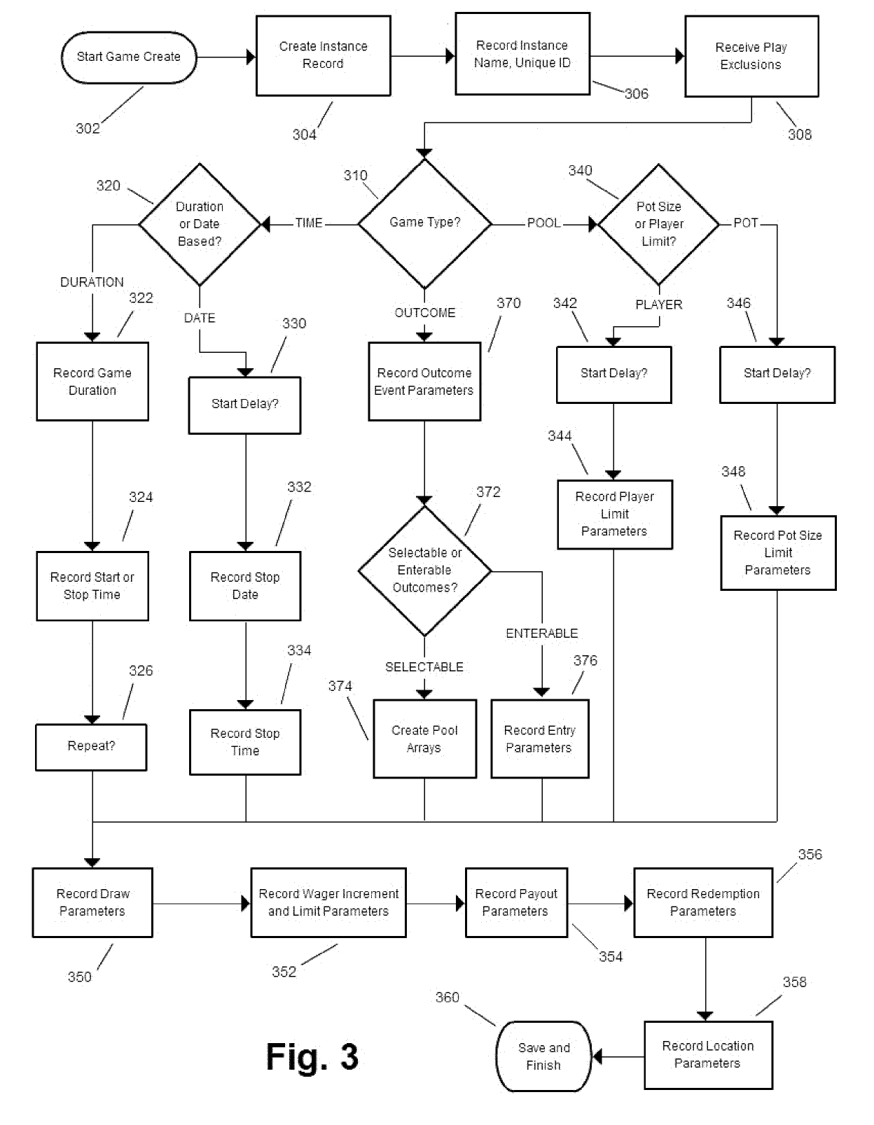

Some of the features of the invented lottery game are described in connection with FIG. 2, which is a flowchart showing an exemplary embodiment of a method related to playing the lottery game. The process of playing an instance of the alphanumeric lottery game begins at 202. At 204, a lottery administrator creates an instance of the lottery game by defining the optional parameters 206 and thereby creating at least one corresponding pool defined by said parameters. A more detailed description of the game creation process is described in connection with the exemplary embodiment shown in FIG. 3 below.

An exemplary embodiment of the invented lottery game can be played generally based on at least three categories of game types defined generally by the manner in which one or more pools are built. At 208, depending upon whether the game instance is time based, pool based or outcome based, the system proceeds to the steps at 210, 230 or 260, respectively. At 210, the start time and stop time of the game (i.e., when the pool is open to betting) is first determined based upon the parameters entered by the lottery administrator. Time based games could be, for example, defined by a specified duration in combination with either a specified start or stop time (“duration games”), or by a specified stop date and time (“date games”). The former type is preferably utilized for shorter length games and the latter type for longer length games. However, the use of either parameter set or other time based parameters adapted to reach an equivalent result are possible and are considered encompassed herein.

Duration games run for a specific period of time, and may repeat if desired. For instance, a duration game can be created that lasts for one hour, wherein 24 consecutive games are played each day. It will be understood that duration games can be configured for any desired period of time, including but not limited to seconds, minutes, hours, day, weeks, months, years, decades, etc. Date games, alternatively, are configured to terminate at specific times on specific dates. For example, the lottery administrator can choose to set up specially marketed games that conclude on holidays. It will be understood that date games can be set up to run for short periods of time in order to provide fast play, or in some preferred embodiments date games are configured to end each day of the year, and for example remain open for a year. Such a configuration enables all players to place bets within a lucky game instance corresponding to, for instance, a birthday or other special anniversary date.

Returning to 210, based on a preferably minimal number of parameter values stored in a lottery administration server 14, the start and stop time for the game instance is calculated. For example, using a duration parameter of one hour and an end time parameter of 2:00 pm, the start time is calculated at 1:00 pm and the stop time as 2:00 pm. For date games, the end date and time are equivalent to the stop time, and the start time can begin at game creation, a specified time after game creation (e.g., chosen by a date and time picker software module, or by the entry of a delay durational value), or calculated from the stop time and game duration value. Those skilled in the art will appreciate that other comparable methods of determining the date and time characteristics of a game instance may be employed without departing from the scope of the invention. Then at 212, the start time occurs and the pool is opened to wagering.

While the pool is open, players may participate in the game by entering wager amount and play information into a gaming device, which is recorded by the system at 214. When a player completes a wager, one or more accepted entries are created in the pool array corresponding to the game instance and the player's wager amount is received. Several means of receiving such payments are known in the art, and it should be understood that the particular method used is not considered limiting. Furthermore, non-monetary based versions of the invented game may be implemented according to this disclosure that would not require payments to be collected. Rather, an internal accounting system or subsystem can be used to apportion nonmonetary playing “token” or “virtual coin” denominations, for instance.

Once the wager is recorded at 214, the system may optionally be configured to calculate and display certain information about the game, such as the total number of current game participants, or the current odds of winning the pool for a single unit wager, as at 216. For time based pools, the odds of winning the pool may change over time while the pool is open to wagering. For added excitement, and to inform players of their current odds at any given time, the odds may be displayed on a display of the gaming device, or on a public display in a particular location. For example, the odds can update for display on a webpage, directly on a screen of the gaming device, or a larger conspicuously placed graphical display (e.g., a textual ticker display, projected image, or an LCD, plasma, CRT or other such display) in common areas of public establishments (e.g., a casino floor). In a preferred embodiment, the system is configured to display the current number of pool participants, along with a periodic random display of individual plays wagered upon. For instance, a display above a bank of freestanding gaming devices at a casino can be configured so that, at a time during which the pool is open for a game having 465 current participants wherein one participant placed a wager on the bet “@GeorgeWashington” the display may configured to read “465 Wagers! Including: @GeorgeWashington”. The graphical displays may receive display instructions from the lottery administration server, the gaming device, or a combination thereof. In some time-based embodiments, it may be desired to offer game instances for which the odds of winning for any single entry are known and constant. In those embodiments, the wager pool may adjusted by appending house entries therein when the time parameter triggers the closing of the wager pool. In high-volume applications, the lottery administration server may further be configured to close the wager pool when the number of accepted entries equals the number of total entries needed to meet a specific, predetermined chance of winning, prior to the expiration of the time allotted for the game in the time parameters.

For time based games, the lottery administration server and/or gaming device(s) are configured, at 218, to compare the current time at a given moment to the stop time calculated (or retrieved) at 210. The comparison can test a time keeping module in relation to a stored value, or may be implemented as a durational timer, for instance. If the time has not yet expired for the game, the system remains open to receive and record wagers at 214. If the time limit has been reached, then the pool is closed, as at 220.

Turning to 230, if the system is administering a pool based lottery game, the parameters of the game instance are queried in order to determine if there is a delay to the start of the game. As mentioned, pool based games may either begin immediately upon creation, or after a specified delay duration, or at a specified start date and time. If a delay parameter was defined at 206, then the system waits to open the pool to wagering until the start time, as at 232. If the game instance was to begin immediately upon creation, then the pool is opened to wagering, as at 234.

Next, at 236, wagers are recorded into the pool array as discussed in connection with 214, and the optionally displayed odds, play information or a combination of both are calculated and displayed, if desired, at 238. Pool based games differ from time based games in that the pool is defined not by the number of players who choose to participate during the predefined duration of the game, but by either a specific pot size limit (i.e., total money wagered) or by a specified number of players (i.e., the first 100 players that participate in the game). That is, in the former case the pool is closed when a specified dollar amount has been paid into the pool, and in the latter case the pool is closed when a specified number of distinct plays have been made. It will be appreciated that a pool based game defined by a specified bet increment and pool size will have fixed, known odds, whereas those defined by player limit can vary based upon the size of the amounts wagered for each play, unless restricted to be equal to the bet increment.

By way of example, a bet increment of $5 in a pool based game with a pot size limit of $100 will always result in a 1/20 chance of winning for each $5 wagered on a play. Assuming a given house “take,” the payout odds, expected returns, etc. for multiples of the bet increment are fixed based upon the game parameters. On the other hand, suppose a pool based game is defined with a bet increment of $5 and a player limit of 10, with no maximum wager size. In this case, the odds of winning can change as each play is made, depending upon the wager amount. Note that a 10 player limit does not necessarily mean that exactly 10 people must participate in the game—one player might make wagers on two separate plays (e.g., “777” and “@Bob”) resulting in a maximum number of actual players being 9, given that 8 other participants place 8 distinct bets.

At 240, the system determines if the wager recorded at 236 results in either the pot size or player limit being reached. Note that the wager recorded at 236 is preferably not finalized, or posted, until the pool limit parameters are checked, as the wager may be unacceptable in that, for example, its posting may result in the pot size limit being exceeded for the game. In that case, the player may be asked to make a new wager or be notified that the pool has closed. Alternatively, acceptable wager limits can be displayed during bet creation to assist the player in that regard. If the pool based limit is reached at 240, the system continues to 242, wherein the pool is closed to further wagering.

In addition to time or pool based games, the invented system may be used to administer outcome based lottery games as well. Lottery administrators may wish to associate game instances with real-world events and occurrences to increase excitement, participation and game play variation. For instance, the invention may be applied so that games are directed to events or themes related to sporting games or leagues, television shows or other newsworthy events such as a presidential election, for instance. These outcome based lottery games are administered by associating an outcome with each bet placed, in addition to the alphanumeric play and wager amount.

In one embodiment, a group of time based game instances is created by a lottery administrator wherein each game instance has an identical time interval during which its pool is open to wagers. Each of these connected pools is designated as representing a unique outcome to a real-world event, such as every major league baseball player active at that time. By connecting multiple game instances, a lottery administrator may thus create games corresponding to an event.

To make a play, a player chooses, via a gaming device, the unique event outcome on which they would like to place a bet, for instance the number “270” in the set of unique possible outcomes made up of all possible numbers of Electoral College votes that may be received by a specified candidate for a specified presidential election. A pool corresponding to “270” represents the array into which the player's play will thus be recorded, and the player does so by choosing a play as described and a wager amount.

The outcome-based configuration of the invented game can optionally permit the winnings of all connected pools (e.g., one for every integer from 0-538 in the example above) to be apportioned to the players who made plays in the pool corresponding to the correct choice, or there may be a second round wherein the winning pool is subject to a random drawing as described herein, or any other desirable configuration. The outcome based games may be adapted to correspond to events wherein multiple unique outcomes are possible. For instance, an outcome based game instance may be configured having a pool for each major league baseball player currently active, and wherein all such game instances are open for some interval ending prior to a specific 24-hour period. The pools corresponding to each player who hit a home run during the 24-hour period are designated to be the winning game instances, and the total outcome based game instance winnings can be proportionately distributed, or a random drawing may be conducted to determine the ultimate winner, for example. By way of further example, the alternative, in which a single pool in an outcome based game instance may be chosen, would occur wherein the first player to hit a home run in a given time interval is used to determine the winning pool.

The connected pools may be discretely defined by the administrator as a finite number of choices when setting the parameters for such an outcome based game instance, as previously described. Alternatively, the connected pools may be determined by software based analysis or manual sorting after betting has closed in the particular outcome based game instance. For example, a themed game may be created in one embodiment by forming a question, such as “What is your favorite thing to do on the beach?” Each bet made by a player may later be categorized into groups of common answers in a manner similar to the popular game Family Feud, whereby each answer category encompasses an array of plays made by players. The proceeds of the outcome based game instance may then be paid to a randomly chosen winner of the most populous array, distributed pro rata to the players whose plays are contained within the most populous array, or other such distribution schemes as desired without limiting the scope of the invention herein.

While preferred embodiments utilize separate pool arrays to store bets made that correspond to particular outcomes, it should be understood that a single array may be utilized in the administration of an outcome based game instance. A single outcome based array would include, for each entry recorded therein, the play made, the wager amount, and the outcome associated with the bet as chosen by the participant that placed the bet. Note that other equivalent database structures for tracking the game information are possible and are considered to be encompassed by the disclosure herein. By way of example, a single outcome based game array may contain, for each record, a unique identifier, a play, and an outcome. In a relational database structure, a master game table may associate a bet increment amount with the single outcome based game array, instead of storing the bet increment amount within each record. Similarly, and with respect to all game types described herein, the pool associated with the game instance may record only plays and total wager amounts, and a second array may be created for the purposes of drawing the winner after betting is closed based upon the bet increment parameter selected during game creation by the lottery administrator.

Returning to FIG. 2, at 260 the one or more pools associated with an outcome based game instance are opened, wherein the number of pools may be based upon the number of event outcomes and/or the database configuration within the lottery administration server. Start times for the initial opening of the one or more connected pools are determined as previously described. Note also that additional connected pools may be opened at 260 during game play if the selection of outcome to be associated with a particular bet is not chosen from a pre-selected list of possible outcomes, but rather is entered manually by the player.

Wagers are then recorded at 262 in one of the manners, as described above. Again, game information may be calculated and/or displayed in connection with an outcome based game at 264, such as a histogram displaying outcome selections, odds, individual plays, and the like. At 266, the lottery administration server queries the outcome based game instance parameters and determines whether the event is over, an outcome has been selected, or time constraints have been met, for instance. If not, the system continues to accept and record bets at 262. If the game is determined to have ended, the one or more pools are closed to further bets, at 268.

In some embodiments, the odds of winning any particular game instance may be predetermined by requiring the wager pool to contain a specific number of predetermined entries. For example, independent of the number of entries made, the number of wagers, or time constrictions, the wager pool may have a predetermined and discrete number of entries. A termination parameter that defines the end of the instance and thus the closing of the pool to further wagers is a separate parameter from the wager pool size in these instances. In these embodiments, the wager pool size is constant for a particular game instance, which enables the lottery administrator to define the expected outcome in relation to any one wager as a constant value. For example, a bet increment of $1 with a wager pool size of 10,000 will always have a 1:10,000 odds of winning for each bet placed per bet increment. In these embodiments, when the pool is closed, as at 220, 242 or 268, the pool array may be populated with “house” entries. The selection of a house entry as a winner at step 250 will result in no player winning. Before selecting a winner at 250, the pool array is populated with randomized entries. The population step may occur via random generation by a software routine, or by populating with the appropriate number of entries selected from a large database of house entries, for instance. In these embodiments, a single player may play against the house or few other players, with the remaining entries in the pool array entered in favor of the house, or lottery administrator. Those skilled in the art will appreciate that each pool array may be populated with predetermined house entries taken from a single table in a database comprised of many randomize entries, a temporary table constructed with house entries based upon game parameters (e.g., defining character types and number limits), or that a predetermined game instance pool array may be randomly populated with replacement as one or more players make entry into the pool, for instance.

For outcome based game instances in which a second, random drawing will be conducted to determine a final winner or winners, step 270 may be carried out wherein one or more winning pools are selected from all of the connected pools for the particular outcome based game instance. For example, where the final number of electoral college votes received by a presidential candidate was determined to be “308” the pool associated with that particular outcome is selected at 270 for treatment as described below in connection with step 250. Note that it is considered an equivalent for a pool to be created during step 270 containing all bets placed on the winning outcome, in the situations in which a single array is used to record bets made during the course of a game instance. Variations on the method of storing and drawing winners may be made without departing from the intended scope of the invention, as other comparable or equivalent means may be considered computationally more efficient, or in light of other similar considerations.

For all game instances, the lottery administration server proceeds to execute a draw software routine to randomly select one or more winners or finalists, depending upon the particular configuration, at 250. For example, in a single pool, the draw software routine may be configured to randomly select one entry in the array of entries, with that selected entry designated as the winner. In other embodiments, the draw software routine may randomly select one character at a time beginning with the leftmost characters, discard all entries that do not match the selected character, and so on until there is one entry to designate as the winner. In the latter method, the characters that are randomly chosen at each step may be displayed publicly in a manner similar to numbered ball lottery drawings, in order to increase player excitement and suspense. While several embodiments are described herein, the particular method used to select winners is not necessarily limited, as other selection methods may be combined with the game concepts herein without departing from the scope of the invention. After a winner is selected, regardless of the method of selection, the pot is then disbursed according to the odds tables (e.g., less the house take) at 252, and the process ends at 254.

Some of the features of the invented lottery game are further described in connection with FIG. 3, which is a flowchart showing an exemplary embodiment of a method related to the lottery game, in particular the creation process made available to a lottery administrator by the lottery administration system. As will be understood, the invented lottery game permits lottery administrators to offer players a wide variety of lottery games that are different and distinct. By selecting combinations of rule variations, lottery administrators are able to create distinct instances of the overall lottery game, wherein each instance corresponds to one or more pools comprising a total pot size defined by the wager amounts paid by the players of that particular game instance, and a pool array of plays corresponding to the plays likewise made by the players. The pot size is the amount from which the winnings or proceeds are calculated and paid to players after the lottery drawing.

A lottery administrator begins the game creation process at 302. The game creation interface described in connection with FIG. 3 can be made available via a secured website, or for example via a terminal connected to the lottery administration server 14, directly on the lottery administration server 14 itself with input and output devices (e.g., keyboard, mouse and display), or other like methods. Regardless of the access method, a lottery administrator accesses the lottery administration server 14 and begins the game creation process at 302. The remaining steps are shown in a particular order for convenience, it being understood that the exact order is not meant to be limiting unless otherwise stated.

Proceeding to 304, the administrator enters a name for the game they are creating. The name of the game is stored by the server 14 and can be an internal name that is not made available to the players, but is used for internal accounting and tracking reasons, or it may be the actual name of that particular game—e.g., “Snap Lotto,” “Weekly Lotto” or “Lotta Lotto.” In the former case, the public-facing name of the game being created are preferably but optionally associated with the game by including graphical elements that are incorporated into the graphical user interface for that game.

Next, at 306, a unique game number is generated by the server (e.g., 14 in FIG. 1) and associated with the selections being made by the administrator. The unique game number allows the system to track the rule selections, bets made, etc. for that particular game. Note that the step described in 306 may serve also to satisfy the step described in connection with 304, if desired. Optionally, at 308, the lottery administrator may choose to enter a bet exclusion list, or link to a bet exclusion list library, as described above (both linked and game-specific libraries, tables, databases or lists are referred to as simply an “exclusion list” or “list” hereinafter). The list may be comprised of, for instance, unacceptable terms that are racial, sexual, religious, demeaning, derogatory, etc. —a “George Carlin list for want of a better term—that can be continuously updated. With player bets being optionally displayed on a conspicuous screen in a manner similar to the display of the numbers on a keno board, or the winning player's bet being flashed on a public display, the avoidance of offensive combinations is considered preferable.

At 310, the lottery administrator chooses to create a time, pool or outcome based game, thereby proceeding to 320, 340 or 370 respectively. If a time based game is chosen, a preferred embodiment requests that the lottery administrator choose to create either a duration game or a date game. If a duration game is chosen, the lottery administrator inputs parameters such as the desired game duration, at 322, for instance by entering a number of minutes, hours, days, etc. At least one of a start time or stop time parameter is chosen at 324, as one of the two choices can be used with the game duration parameter entered at 322 to calculate the other of the two times. Note that the start time may default to the end of the creation process, for example. At 326, the lottery administrator may chose whether the duration game should repeat—i.e., a new pool opened with identical parameters consecutively, such as the creation of a daily game running from noon to noon every day.

If a date game is chosen at 320, the lottery administrator may chose whether the pool opens immediately upon the completion of the game creation process, or whether to delay the opening time for the pool, as at 330. The delay could be entered as a duration interval calculated from the game creation, or as a specific date and time, for example. The lottery administration then chooses a stop date at 332 and a stop time 334 in order to define the date and time when the pool will close. An option to repeat the date game (not shown in FIG. 3)—annually for instance—may be optionally included as well. Generally, the date game creation process can be used to create games for which the pool will close to further bets at a specific time on a specific date, whatever desired.

Returning to 310, if the lottery administrator chooses to create a pool based game they may in some embodiments be presented with the option of choosing to create a pot size limit or player limit defined game at 340. If a player limit game is chosen at 340, the option to delay the start of the game—i.e., the opening of the pool—is presented at 342, similarly to that described in connection with 330. At 344, the administrator chooses the player limit for the game. When the player limit is reached, the pool will close and the game will proceed to the drawing phase. The player limit is the number of distinct “bets” or “plays”—i.e., alphanumeric character combinations—that are successfully entered into the pool array while the pool is open. For example, a player limit of five would result in the pool being closed after the following entries are received into the pool array: “TOM4”, “#WINNING”, “11Blue”, “@Midnight” and “#YOLOSWAG”. Unless the maximum bet amount is limited to the bet increment (see below), each play may or may not result in multiple entries into the pool array (i.e., the pool array need not be limited to five entries in this situation). Many games of this sort could be created with a wide array of appeal to potential players, for instance such as “First 50” as a game for the first 50 participants, or “First 777” as a game that closes after the 777 plays are made. Note also that preferred embodiments of player limit game instances do not allow identical plays to be made.

If the lottery administrator chose to create a pot size limit game at 340, then they may be again queried for a start delay parameter, as at 346. At 348, the administrator enters the pot size limit that will define the closing of the pool for the particular game being created. For example, a lottery game instance could be created in which the pool remains open until the total amount wagered in the game equals $10 million. Smaller, quicker pots can be created for exciting rapid plays. The actual temporal length of a pot size limit game will of course vary as a function of bet sizes and player participation rates.

Returning again to 310, if the lottery administrator chooses to create an outcome based game, the outcome/event parameters are stored and associated with the game instance at 370. For example, the game duration may be defined in some embodiments, such as by start and stop times. In some embodiments, specific event times may be known, such as for an outcome based game defined for the number of home runs hit by a particular player up to a specific time. In other embodiments, the event time may be unknown, such as for an outcome based game defined for the winner of a NASCAR race, which can end at unpredictable times depending upon weather conditions, caution flags, etc. At 370, the parameters for sufficiently defining the event are entered.

In some embodiments, outcomes may be predefined and finite, such as the possible outcomes to the number of electoral college votes received by a presidential candidate. In others, outcomes may be indefinite, such as the answer to a question that may require free-form answer entry. At 372, the system directs the administrator creating the game to enter whether the outcomes are selectable or enterable. In the former case, the administrator enters the possible outcomes at 374. In the latter case, at 376, the administrator may optionally define any entry parameters such as rules that limit the outcome possibilities that are enterable by a player. In some embodiments those parameters may be, for instance, character limits or other such rules.

Once the pool parameters have been chosen, in all cases the lottery administrator may be queried for draw parameters at 350 such as a draw time delay and particular rules that may define how a winner(s) is chosen. The draw time delay is the time period between the close of the pool and the time of the drawing, and could be zero or greater. It may also be entered alternatively as a specific drawing date and time, for instance, for added suspense. Drawings may, depending upon the specific game, be carried out by random selection of an entry from the pool, by character-by-character elimination, or based on outcome-specific selections made by the administrator, for instance.

At 352, the bet increment and/or wager amount limit parameters are optionally entered. A default bet increment can be utilized, for example $1, in cases for which the bet increment or total wager limit is not provided. As previously described, the bet increment can be any denomination, but is preferably provided in whole dollars or other such denomination representing real or virtual currencies. Players can be restricted from attempting to “buy” a pot through the use of a maximum wager limit, although odds tables are expected to be provided in which a positive expected return is not likely to occur regardless of the amount wagered. Of course, the use of the smallest monetary denomination (e.g., $0.01) as a bet increment without a maximum wager limit will result in any desirable wager amount being available for placement by a player in game instances involving United States currency.

At 354, the lottery administrator proceeds to enter the payout—or odds table—parameters for the game, which may for example define the house take, the percentage of the remaining pot where multiple winners are selected at the drawing, and other such desired parameters. This step may also be automatically included if so desired.

Any optional rules and parameters for the redemption process for winning plays may be entered at 356 and associated with the game instance by the lottery administration server. These items include, for instance, a time period for redemption, penalties for late redemption and the like.

Optionally, at 358, the lottery administrator may desire to limit the availability of a particular game instance to certain gaming devices. By entering location parameters, games may be created, for instance, that are only available to players in a particular casino or casino chain, or those using a particular gaming device or one of a plurality of gaming devices. The game alternatively may be made available only through certain branded convenience stores, or via the web only. This option allows generally for the geographic or demographic tailoring of specific types of games, simultaneously increasing player excitement and participation, as well as the potential for lottery game revenues to the lottery administrator.

Finally, at 360, the lottery administrator chooses to save and finish the game creation process. The game instance will then be made available to players on gaming devices according to the game parameters provided via this process.

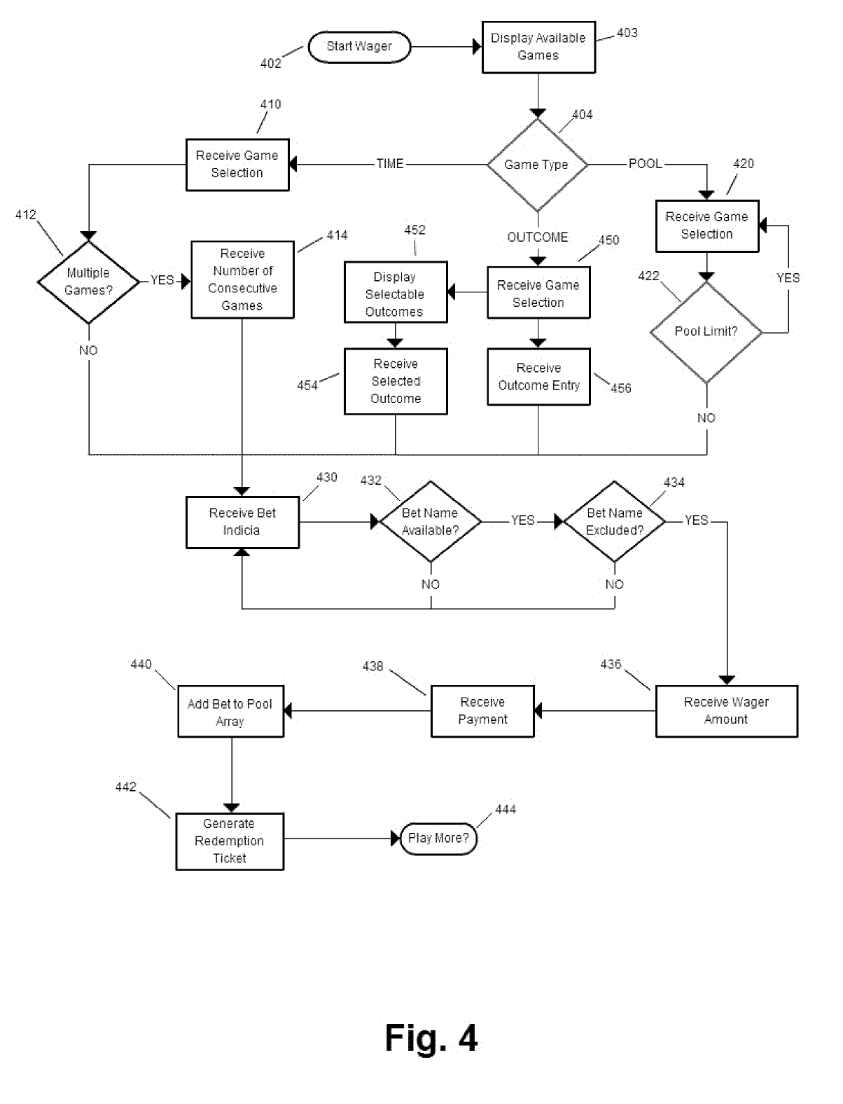

Players interact with a gaming device to participate in a game instance as shown in an exemplary embodiment of a system and method for playing the game depicted in connection with the flow diagram in FIG. 4. The process begins at 402, and proceeds to 404 where the player is queried by a user interface (UI—graphical or otherwise) displayed on the gaming device as to the game in which they wish to participate. This selection process can be configured as a multiple-screen selection process to narrow the selections from many to few, via a single screen, or any other such desirable method. For the purposes of illustration and understanding, the process for game creation has been divided between time, pool and outcome based games, as the selection of any one may result in the performance of slightly separate functions by the gaming device, lottery administration server or a combination of both in pursuit of efficiencies. Generally, however, the invented method includes receiving from a player a bet including an alphanumeric play, a wager amount, and any other secondary parameter choices applicable to the particular instance of the game chosen, such as the selection or entry of an outcome.

If a time based game is chosen at 410, the player is queried whether they would like to bet on consecutive games (e.g., the next five one-hour games), as at 412. Other such optional parameters in accordance with the game type chosen may be received at 412 by the gaming device as well. If the player answers in the affirmative, then at 414 the number of consecutive games of the type chosen at 410 is received. Otherwise, the process proceeds to 430 as further explained below.

If a pool based game is chosen at 420, the process may test the pool limits to determine whether the player's play and wager can be added to the pool array and pot, as at 422. If pool limits are reached, then the process returns to 420 (or 404) where the player is asked to choose another game. Otherwise, the process proceeds to 430.

If an outcome based game is chosen at 450, the player is either presented with a display of selectable outcomes at 452, or is permitted to enter an outcome at 456, depending upon the outcome based game parameters and type. If applicable, selectable outcomes are received at 454, and the system proceeds to step 430.

At 430, the player enters the play combination of alphanumeric characters chosen from the set of available alphanumeric characters that the player wishes to wager upon. Embodiments of the system may also be optionally configured to randomly generate a play for a player, is so desired. As discussed previously, the play will correspond to the player's entries in the pool array, wherein each entry has an equal chance of being drawn in a random drawing after the pool, and consequently the pool array, is closed to wagering/further entries. Once the player's bet indicia combination is confirmed by the player at 430, the pool array is optionally queried and compared to the bet entered at 430, at 432. If an identical entry is found in the pool array, the bet has already been placed (whether by another person or the current player themselves does not matter) and the player may be returned to enter a new bet at 430. If the bet does not exist in the pool array, then the process optionally proceeds to 434, where the play is compared to any exclusion list that may be available. If a match is found within the play, the player is returned to 430.

Next, upon successful comparisons at 432, and at 434 if desired, the amount that the player wishes to wager on the play is received at 436, payment is received at 438, and the bet is added to the pool array, at 440. At any point in the process the requested play can be tested against the pool parameters to determine if the amount requested will result in an unacceptable result to the game based on the rules (e.g., at or before 440). For example, in a pot size limit game that has a limit of $100 with $90 already wagered, an attempt to wager $15 at 436 will not be accepted.

If the wagered amount and the play are acceptable under the game instance parameters and contemporaneous conditions, a redemption ticket generated at 442. Redemption ticket generation need not be accomplished by the generation of a physical ticket, but could be otherwise electronically generated as redemption information for instance, if so desired. After redemption ticket generation, the process is complete, and at 444, the player is queried about whether they would like to play additional wagers.

Note that when a single winner is desired, it is preferred that only one player be permitted to wager on a given combination in a game, but they can easily bet it multiple times (i.e., a multiple of the bet increment) thereby increasing their odds of winning, if desired. The claim ticket, redemption ticket or claim/redemption information provided to the player upon wager completion may be cashed in at the cashier for winners. For example, bar codes may be printed on tickets to verify winners and the winning combination for each numbered game will be displayed and available at each kiosk or on screens in casino situations and the like. Of course, the redemption ticket may be in any desirable form, such as a physical slip, an email, an in-app stored barcode on a mobile device, or the like. Limiting entries so that all plays must be unique in a given pool may be considered beneficial, as the unique play is all that is needed to identify the winner—in effect making the redemption ticket a bearer instrument of sorts. That is, no personally identifying information is needed while participating in the game, or as a prerequisite to placing a bet.

Furthermore, aspects of the invention make it very easy for players to place multiple wagers for a given play on any number of games quickly. For example, a player may wish to play “LUCKY7” in every weekly game (i.e., ending on Saturday evenings each week) for an entire year, and wager $260, or $5 for each of 52 weeks in a year. The gaming device play selection process should be configured to allow players to easily make many consecutive wagers, as described in connection with FIG. 4. This aspect of the invention will be perceived as greatly benefiting lottery administrators that operate destination locations, such as casinos and resorts, due to the fact that such an option will allow participants to make plays for games occurring while they are not present (i.e., a revenue opportunity for infrequent visitors to a specific locale).

Additionally, it is preferable that provisions be made so that a pool that closes with a single play refunds the entire wager to the player who made the play. That is, the house take is preferably not taken from a single entry game.

By way of example, take a $1 bet increment time based game in which, when the pool closes, there has been three wagers made. Bettor 1 wagered $5 on the play “MFTY”, Bettor 2 wagered $1 on “GoBucks” and Bettor 3 wagered $9 on “#Northwestern”. The game array is as follows:

TABLE 1

| Array position | Bet/Play |
|---|---|
| 1 | MFTY |
| 2 | MFTY |
| 3 | MFTY |
| 4 | MFTY |
| 5 | MFTY |
| 6 | GoBucks |
| 7 | #Northwestern |
| 8 | #Northwestern |
| 9 | #Northwestern |
| 10 | #Northwestern |
| 11 | #Northwestern |
| 12 | #Northwestern |
| 13 | #Northwestern |
| 14 | #Northwestern |
| 15 | #Northwestern |

The pot size is $15. If the house take is $3, then each of the 15 entries in the pool array corresponds to a 1/15 chance of winning $12. A random number generator is used to choose from the range of 1-15. Alternatively, a physical representation could be used, although electronic drawing methods are preferred. The winning play corresponding to the drawing is displayed, and the winner who wagered on that bet may collect their winnings.

In some embodiments, it may be desirable to apply a winner selection method that emulates or is similar in nature to traditional numbered ball drawings, in order to provide variety and increase excitement, suspense and participation for players. This may be especially desirable in connection with very large pools of players, in which many character combinations have been played. As an example, consider a $1 bet increment time based game in which, when the pool closes, there has been fifteen wagers made, and the game array is as follows:

TABLE 2

| Array position | Bet/Play |
|---|---|
| 1 | MFTY123 |
| 2 | Moose58 |
| 3 | 7777777 |
| 4 | MFTY!!! |
| 5 | Money00 |
| 6 | LuckyLu |
| 7 | Money$2 |
| 8 | MSU#fan |
| 9 | @Robert |
| 10 | Casino$ |
| 11 | Money$$ |
| 12 | NWU#fan |
| 13 | Monkey5 |
| 14 | Matthew |
| 15 | USA#USA |

In lottery picker-type games, it is considered preferable to limit the character count to a specific number of characters (i.e., minimum=maximum) so that each entry has a matching number of characters that are usable in the drawings method. Alternatively, a range of total characters permitted may be used, and multiple drawings are held for each discrete total character count. For instance, where entries are permitted with 6-8 total characters, a separate drawing can be held for 6-character entries, 7-character entries, and 8-character entries.

In the case of the array shown in Table 2, a draw software routine is executed that identifies a list of characters in the first position. Here, beginning at the left (preferred but not required), the fifteen entries have used C, L, M, N, U, 7 and @ in the first position. The routine randomly chooses one of these characters—suppose M is chosen—and proceeds to toss out those that do not begin with the character M.

TABLE 3

| Array position | Bet/Play |
|---|---|
| 1 | MFTY123 |
| 2 | Moose58 |
| 3 | MFTY!!! |
| 4 | Money00 |
| 5 | Money$2 |
| 6 | MSU#fan |
| 7 | Money$$ |
| 8 | Monkey5 |
| 9 | Matthew |

In Table 3, the draw routine is presented with nine remaining entries beginning with the letter M. It proceeds to the second character, of which A, F, O and S are present. This process is repeated until only one entry matches the character string selected by process of elimination, and the winner is selected. Suppose, for example, that the progression continued until the draw routine had selected M, O, N, E, Y, $ and 2. The entry “Money$2” would then be the designated winner of the pool. Note that, in cases in which there are multiple entries (e.g., because of wagers that are multiples of the bet increment), then the character selection process may be used to weight the random selection process, if desired. Also, there may be several entries that ultimately match the winning combination of characters, in which case the pot may be divided among the winners. A pro rata distribution is possible with the recordation of additional purchase information, but if repeated plays are disallowed there is no need to track who played a particular combination. This may happen if a lottery administrator desires to limit the game instance to only one identical character string play per game on a first played basis, for example. As with traditional numbered ball lotteries, games may also be configured to payout lesser amounts to matching subsets of the final selected string drawn by the routine.

Note that, if both upper and lowercase letters are included for use in the available alphanumeric character set, participants may optionally be put on notice that the play is case sensitive. Doing so will serve to avoid confusion, for example, if the winning entry in the pool array corresponds to the play “GoBucks” and there is at least one other non-winning entry that corresponds to the play “GOBUCKS”. Alternatively, the system can be configured to warn a participant that they are electing to wager on a play that differs from another existing play only by reason of letter case. These same principles hold true for “space” characters, which may be optionally included in the set of available alphanumeric characters, but could potentially cause confusion regarding which player has actually won a game. These considerations should be taken into account when making and using the invention, especially in entertainment areas in which the likelihood of participant intoxication is elevated. In general, the invention may be implemented with an optional step wherein bets are compared, altered or both to improve the gaming experience for players.

Furthermore, some embodiments may be configured to allow two players to place wagers on identical plays, or on similar case-difference plays as described in the previous paragraph. In those embodiments, the lottery administrator may optionally allow for those identical or similar plays to share the pot of winnings. Multiple winners may be permitted in this manner in addition to, or as an alternative to the method wherein multiple pool entries are chosen to pick multiple winners described above. It should be noted that it is preferred, but not mandatory, that identical entries be allowed in conjunction with restrictions on wager size so that a smaller wager has less opportunity to free ride on the increased odds of winning that could be brought about by a larger wager for the same play. For example, it is preferable to avoid the situation in which a first player can wager $150 on “RedWhite&Blue” in a $5 bet increment game, and a second player can wager $5 on “RedWhite&Blue” in the same game, thereby achieving 31 possible winning entries for both players. Alternatively, the proceeds may be shared on a calculated pro rata basis according to the respective wager amounts.

In yet another embodiment, the participant may be queried to determine whether, as the first participant to wager on a specific play, whether they wish to keep the play open for other wagers in order to increase the chances of winning a shared pot. If the player chooses to decline that option, then other game participants will receive an error (see 432 in FIG. 4) and be returned to the play selection process in order to try another combination.

The advantages of the invention further include the ability to create themed games corresponding to, for instance, specific sports teams, sport leagues, and prominent events. The use of connected pool, outcome based game instances as described will further increase excitement and engagement of players participating in the invented games in all, but particularly in, nonmonetary situations, such as via social gaming networks. Social gaming in general may utilize the disclosed concepts of selecting random winners from arrays, the use of alphanumeric indicia sets to identify bets made, as well as connecting game instances. Nonmonetary denominations may be tracked for users and used to incentivize monetary contribution during game play, for example by requiring larger amounts of in-game denominations to access additional game instances or connected game instances. Players may win such denominations through successful participation in game instances, or by purchasing predefined fees for in-game currency packages, for example.

Further advantages of the present invention are provided wherein game instances tailored to fundraising events may be employed, thereby increasing community excitement and involvement. A portion of the total wager pool may be designated to be paid out to specific organizations, such as local sports leagues, schools, non-profit organizations, associations, chambers of commerce, and the like. Connected pool game instances may be utilized to further personalize the application for such events, for example an outcome based game instance can be created for each group participating in a certain fundraiser competition, with the winner being determined by the most funds raised.

In some embodiments, there may be instances in which a large number of outcomes, low participation level, or a combination of both results in a real-world outcome on which no bets were made (e.g., no home runs are hit on a given day). Game parameters may be set to have a variety of payout outcomes, including but not limited to the following: the wagers could be rolled into another game (e.g., home run wagers on the following day), or in the case of a fundraiser a default organization may be designated to receive the winnings as well. Those skilled in the art will understand that the actual configuration will depend heavily upon the specific game parameters defining the game experience. Note also that the inclusion of additional wagering methods may be included in the invented games without departing from the scope of the invention. For example, a “kicker” option may be made available to a player at the wagering stage, wherein an additional payment can be made to increase the player's potential payment, while simultaneously increasing the total pot size, as is known in the art in connection with traditional lottery games. The use and implementation of such schemes in addition to the disclosed system and methods herein will be evident to those skilled in the art.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A computerized system for administrating a lottery game, comprising:
an administration server programmed to perform a lottery game, said server including a termination parameter and a set of valid wager parameters stored in a non-transitory computer readable medium, said valid wager parameters comprising a sequence having a number of characters within a predetermined number range of characters, each selected from a set of possible characters;
a wagering module in electronic communication with said server;
a user computer device especially equipped to establish an interactive electronic communication link with said server, and in association with said wagering module, to receive game rules, request and receive wager and payment information, validate the received wager and payment information, reject the received wager and payment information if said termination parameter is exceeded, and accept validated wager and payment information in a wager pool;
a resolution module in electronic communication with said server and said user computer device, said resolution module programmed to close said wager pool by said termination parameter, establish a prize payout, and randomly select at least one winner from said wager pool.

2. The system of claim 1, wherein:
the set of possible characters consists of upper case alphabetic characters, lower case alphabetic characters, Arabic numerals, and a predetermined set of special characters.

3. The system of claim 2, wherein:
the set of special characters consists of: !, $, @, and #.

4. The system of claim 1, wherein:
the wagering module is programmed to:
verify the received wager information is a sequence having a number of characters within a range of the predetermined number of characters in the valid wager parameters; and
verify that each character in the received wager information is within the set of possible characters in the valid wager parameters.

5. The system of claim 4, wherein:
The wagering module is programmed to verify the received wager information does not contain any sequences of characters contained in a predetermined library of unallowable sequences.

6. The system of claim 1, wherein:
the resolution module is programmed to disburse the prize payout to the at least one winner.

7. The system of claim 1, wherein:
the resolution module is programmed to display the at least one winner on a display.

8. The system of claim 1, wherein:
the resolution module is programmed to add at least one house entry to the wager pool before randomly selecting at least one winner.

9. The system of claim 1, wherein:
the termination parameter is a predetermined date and time.

10. The system of claim 1, wherein:
the termination parameter is a predetermined amount of time after the instance a lottery game is opened for wagering.

11. The system of claim 1, wherein:
the termination parameter is a predetermined number of valid wagers stored in the wager pool.

12. A computerized system for administrating a lottery game, comprising:
an administration server programmed to perform a lottery game, said server including a termination parameter and a set of valid wager parameters stored in a non-transitory computer readable medium, said valid wager parameters comprising:
a predetermined set of outcomes, and
a player identifier, said player identifier comprising a sequence having a predetermined number of characters selected from a set of possible characters;
a wagering module in electronic communication with said server;
a user computer device especially equipped to establish an interactive electronic communication link with said server, and in association with said wagering module, to receive game rules, request and receive wager and payment information, validate the received wager and payment information, reject the received wager and payment information if said termination parameter is exceeded, and accept validated wager and payment information in a wager pool;
a resolution module in electronic communication with said server and said user computer device, said resolution module is programmed to close said wager pool by said termination parameter, establish a prize payout, determine a winning outcome, refine said wager pool by removing all wagers that do not match the winning outcome, and randomly select at least one winner from said refined wager pool.

13. The system of claim 12, wherein:
the set of possible characters consists of: upper case alphabetic characters, lower case alphabetic characters, Arabic numerals, and a predetermined set of special characters.

14. The system of claim 13, wherein:
the set of special characters consists of: !, $, @, and #.

15. The system of claim 12, wherein:
the wagering module is programmed to:
verify the received wager information for the player identifier is a sequence having a number of characters within a range of the predetermined number of characters in the valid wager parameters; and
verify that each character in the received wager information for the player identifier is within the set of possible characters in the valid wager parameters.

16. The system of claim 15, wherein:
the wagering module is programmed to verify the received wager information for the player identifier does not contain any sequences of characters contained in a predetermined library of unallowable sequences.

17. The system of claim 12, wherein:
the resolution module is programmed to disburse the prize payout to the at least one winner.

18. The system of claim 12, wherein:
the termination parameter is a predetermined date and time.

19. The system of claim 12, wherein:
the termination parameter is a predetermined event.

20. The system of claim 12, wherein:
the termination parameter is a predetermined amount of time after the instance a lottery game is opened for wagering.

21. The system of claim 12, wherein:
the termination parameter is a predetermined number of valid wagers stored in the wager pool.
